(19) United States
(12) Patent Application Publication
(10) Pub. No.: US 2025/0170754 A1
(43) Pub. Date: May 29, 2025

(54) AUTOMATED SYSTEMS AND METHODS FOR MANUFACTURING CERAMIC MATRIX COMPOSITES

(71) Applicant: The Boeing Company, Arlington, VA (US)

(72) Inventors: Brian J. Smith, Seattle, WA (US); Lisa C. Zgherea, Auburn, WA (US); Brice A. Johnson, Toledo, WA (US); Sangvavann Heng, Buena Park, CA (US); Christopher R. Brown, Seattle, WA (US); Ricardo A. Fritzke, Sammamish, WA (US); Erik N. Wienhold, Seattle, WA (US)

(73) Assignee: The Boeing Company, Arlington, VA (US)

(21) Appl. No.: 18/892,821

(22) Filed: Sep. 23, 2024

Related U.S. Application Data
(60) Provisional application No. 63/603,977, filed on Nov. 29, 2023.

(51) Int. Cl. B28B 17/00; B28B 23/02; C04B 35/80

(52) U.S. Cl. CPC B28B 17/0072; B28B 17/0081; B28B 23/02; C04B 35/80; C04B 2235/5252; C04B 2235/604

(57) ABSTRACT

A method for manufacturing a ceramic matrix composite structure includes steps of: (1) picking up a ply of a ceramic matrix composite material at a staging location; (2) removing a bottom backing layer from the ply at a backing-removal location; (3) placing the ply on a forming surface at a forming location after removing the bottom backing layer; (4) compacting the ply on the forming surface; (5) removing a top backing layer from the ply after compacting the ply on the forming surface; and (6) inspecting the ply after compacting the ply on the forming surface.

### PRIORITY

This application claims priority from U.S. Ser. No. 63/603,977 filed on Nov. 29, 2023, the entire contents of which are incorporated herein by reference.

### GOVERNMENT CONTRACT

This invention was made with Government support under contract numbers ARM-TEC-21-02-F-34, ARM-TEC-22-01-F-02, and FA8650-17-C-5700 awarded by the Department of Defense. The government has certain rights in this invention.

### FIELD

The present disclosure relates generally to composite manufacturing and, more particularly, to systems and methods for a fully automated pick, peel, place, form, compact, and inspect process used during the manufacture of ceramic matrix composite materials.

### BACKGROUND

Ceramic matrix composites have different tack and texture than polymer matrix composites and, therefore, require different methods of processing. Ceramic fibers of ceramic matrix composites are more brittle and stiffer than carbon fibers of polymer matrix composites. More brittle and stiffer fibers along with different organic tackifier constituent resin of the ceramic fibers require different methods of processing during manufacture of ceramic matrix composite structures.

A typical ceramic matrix composite structure is manufactured using a hand-layup process. A drawback in using a hand-layup process to manufacture a ceramic matrix composite structure is variability of quality and consistency of the ceramic matrix composite structure. As such, manual inspection and rework are often required. Another drawback is that the hand-layup process is time-intensive and requires skilled technicians. The overall result is increased cycle time as well as increased labor costs to manufacture the ceramic matrix composite structure.

Accordingly, those skilled in the art continue with research and development efforts in ceramic matrix composite manufacturing.

### SUMMARY

Disclosed are examples of a method for cleaning a ceramic matrix from a compaction roller and a system for compacting a ceramic composite material. The following is a non-exhaustive list of examples, which may or may not be claimed, of the subject matter according to the present disclosure.

In an example, the disclosed method includes steps of: (1) picking up a ply of a ceramic matrix composite material at a staging location; (2) removing a bottom backing layer from the ply at a backing-removal location; (3) placing the ply on a forming surface at a forming location after removing the bottom backing layer; (4) compacting the ply on the forming surface; (5) removing a top backing layer from the ply after compacting the ply on the forming surface; and (6) inspecting the ply after compacting the ply on the forming surface.

In an example, the disclosed system includes a pick and place apparatus, a peeling apparatus, and an inspecting apparatus. The pick and place apparatus configured to pick up a ply of a ceramic matrix composite material at a staging location. The pick and place apparatus is also configured to place the ply on a forming surface at a forming location. The pick and place apparatus is further configured to compact the ply on the forming surface. The peeling apparatus is configured to remove a bottom backing layer from the ply at a backing-removal location before the ply is placed on the forming surface. The peeling apparatus is also configured to remove a top backing layer from the ply after the ply is compacted on the forming surface. The inspecting apparatus is configured to inspect the ply after the ply is compacted on the forming surface 160.

Also disclosed are examples of a portion of an aircraft manufactured according to the method or utilizing the system.

Further disclosed are examples of a ceramic matrix composite structure manufactured according to the method or utilizing the system.

Other examples of the system and the method will become apparent from the following detailed description, the accompanying drawings, and the appended claims.

### BRIEF DESCRIPTION OF THE DRAWINGS

FIG. 1 is a flow diagram of an example of a method for manufacturing a ceramic matrix composite structure;

FIG. 2 is a flow diagram of an example of a step of picking up a ply of ceramic matrix composite material, according to the method of FIG. 1;

FIG. 3 is a flow diagram of an example of a step of removing a bottom backing layer from the ply of ceramic matrix composite material, according to the method of FIG. 1;

FIG. 4 is a flow diagram of an example of a step of placing the ply of ceramic matrix composite material on a forming surface, according to the method of FIG. 1;

FIG. 5 is a flow diagram of an example of a step of compacting the ply of ceramic matrix composite material on the forming surface, according to the method of FIG. 1;

FIG. 6 is a flow diagram of an example of a step of removing a top backing layer from the ply of ceramic matrix composite material, according to the method of FIG. 1;

FIG. 7 is a flow diagram of an example of a step of inspecting the ply of ceramic matrix composite material on the forming surface, according to the method of FIG. 1;

FIG. 8 is a schematic block diagram of an example of a system for manufacturing a ceramic matrix composite structure;

FIG. 9 is a flow diagram of an example of an aircraft manufacturing and service method; and

FIG. 10 is a schematic block diagram of an example of an aircraft.

### DETAILED DESCRIPTION

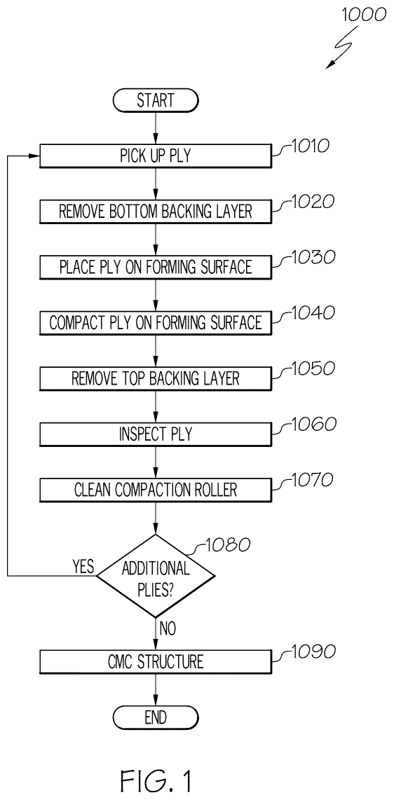

Referring generally to FIGS. 1-8, by way of examples, the present disclosure is directed to a method 1000 and a system 100 for manufacturing ceramic matrix composite (CMC) structures. Examples of the method 1000 and the system 100 disclosed herein enable an automated and integrated Pick and Place (PnP) process, forming and compaction process, and inspection and re-work process for various ceramic matrix composite materials. While examples of the method 1000 and the system 100 provide particular advantages and benefits related to manufacturing ceramic matrix composite structures, one or more portions of the method 1000 and/or the system 100 can also be used in manufacturing other polymer and non-polymer composite structures.

The specific construction of the ceramic matrix composite structures and methods for manufacture thereof and the industry in which the structures and methods are implemented may vary. By way of example, the disclosure describes ceramic matrix composite structures and methods for manufacturing at least a portion of an aircraft. The ceramic matrix composite structures and methods for manufacture thereof may be implemented by an original equipment manufacturer (OEM) in compliance with commercial, military, and space regulations. It is conceivable that the disclosed ceramic matrix composite structures and methods for manufacture thereof may be implemented in many other ceramic matrix composite manufacturing industries.

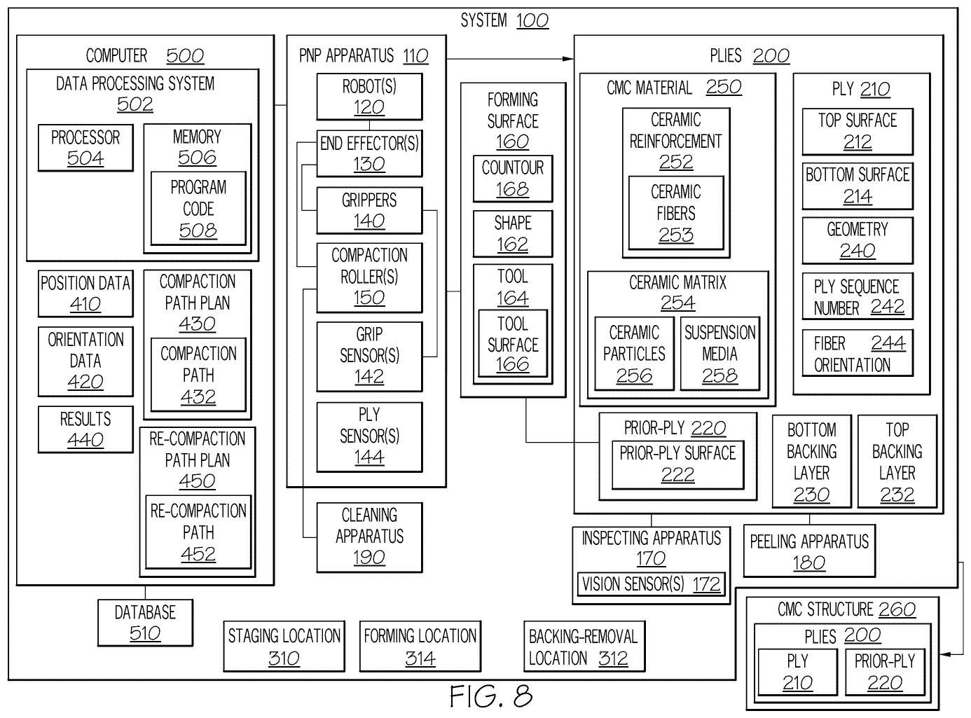

Referring initially to FIG. 8, ceramic matrix composites (CMCs) are a subgroup of composite materials and a subgroup of ceramics. Ceramic matrix composites include a ceramic reinforcement 252 embedded in a ceramic matrix 254. Both the ceramic reinforcement 252 and the ceramic matrix 254 can include any ceramic material, including carbon and carbon fibers. In one or more examples, a ceramic matrix composite material 250 is a ceramic composite and includes the ceramic reinforcement 252 and the ceramic matrix 254.

In one or more examples, the ceramic reinforcement 252 is pre-impregnated with the ceramic matrix 254. In such examples, a ply 210, such as any one of a plurality of plies 200, of the ceramic matrix composite material 250 can also be referred to as a ceramic matrix composite prepreg.

In one or more examples, the ceramic reinforcement 252 includes ceramic fibers 253, such as at least one of carbon reinforcement fibers, silicon carbide reinforcement fibers, alumina reinforcement fibers, alumina silica reinforcement fibers, aluminum nitride reinforcing fibers, silicon nitride reinforcement fibers, mullite reinforcement fibers, silica/quartz reinforcement fibers, basalt reinforcement fibers, and zirconia reinforcement fibers. Other suitable reinforcement materials are also contemplated for use as the ceramic reinforcement 252.

In one or more examples, the ceramic matrix 254 includes at least one of a carbon matrix, a silicon carbide matrix, an alumina matrix, an alumina silica matrix, an aluminum nitride matrix, a silicon nitride matrix, a mullite matrix, a geo-polymer matrix, and a zirconia matrix. Other suitable matrix materials are also contemplated for use as the ceramic matrix 254.

In one or more examples, the ceramic matrix 254 includes ceramic particles 256 dispersed in a suspension media 258 (e.g., fluid or other vehicle). In one or more examples, the ceramic matrix 254 is an aqueous suspension (e.g., the suspension media 258 includes an aqueous media). In one or more examples, the ceramic matrix 254 is a non-aqueous suspension (e.g., the suspension media 258 includes a non-aqueous media). The ceramic matrix 254 has various viscosities depending on the suspension media 258 used. In one or more examples, the ceramic particles 256 include at least one of carbon particles, silicon carbide particles, alumina particles, alumina silica particles, aluminum nitride particles, silicon nitride particles, mullite particles, geo-polymer particles, and zirconia particles. Other suitable materials are also contemplated for use as the ceramic particles 256.

The present disclosure recognizes that ceramic matrix composites have different tack and texture than polymer matrix composites (PMC). As an example, the fiber reinforcement material (e.g., ceramic reinforcement 252) of a fabric-based ceramic matrix composite is more brittle and stiffer than the fiber reinforcement material of a fabric-based polymer matrix composite (PMC). As another example, the matrix material (e.g., ceramic matrix 254) of a fabric-based ceramic matrix composite is less viscous and has different tack characteristics than the matrix material of a fabric-based polymer matrix composite. As such, traditional manufacturing techniques and tools used for polymer matrix composites are not suitable for use with ceramic matrix composites and ceramic matrix composites require different methods and systems for processing.

In one or more examples, the method 1000 and the system 100 disclosed herein provide a fully automated process from programming to final inspection specifically designed for the material requirements of ceramic matrix composite layups. A fully automated process for picking, peeling, placing, forming, compacting, inspecting, and re-compacting (as needed) of ceramic matrix composites offers improved quality and repeatability, reduced cycle time, and reduced touch time. In various examples, the automated operations and processes enabled by the method 1000 and the system 100 includes automated robotic path planning, ply pick up, ply inspection, bottom film peel, ply placement, rollout compaction, top film peel, ply inspection, re-work compaction, and final ply inspection.

The present disclosure recognizes that a robotic PnP layup process for fabric-based ceramic matrix composites (e.g., CMC prepregs) requires controlled placement of the ply 210 of the ceramic matrix composite material 250 on a forming surface 160 and specialized compaction after placement to remove air pockets and wrinkles and to conform the ply 210 to the shape or contour of a layup tool before each subsequent ply is placed. As such, examples of the method 1000 and the system 100 include unique tools for automated picking, placing, and compacting the ply 210, automated removal of backing films, automated and adaptive compaction path planning, automated ply alignment using state-of-the art vision systems, in-situ inspection and automated generation of rework paths, if necessary, and automated inspection of ply location and ply orientation.

FIG. 1 illustrates an example of the method 1000 for manufacturing the ceramic matrix composite structure 260. FIG. 8 illustrates an example of the system 100 for manufacturing the ceramic matrix composite structure 260. The following are examples of the method 1000 (FIG. 1), according to the present disclosure. In one or more examples, the method 1000 is implemented using the system 100 (e.g., FIGS. 8). The method 1000 includes a number of elements, steps, and/or operations. Not all of the elements, steps, and/or operations described or illustrated in one example are required in that example. Some or all of the elements, steps, and/or operations described or illustrated in one example can be combined with other examples in various ways without the need to include other elements, steps, and/or operations described in those other examples, even though such combination or combinations are not explicitly described or illustrated by example herein.

Referring to FIG. 8, as will be described in more detail herein, in various examples, the system 100 includes a number of operational components, including one or more of a pick-and-place (PnP) apparatus 110, a peeling apparatus 180, an inspecting apparatus 170, a cleaning apparatus 190, and a tool 164. In various examples, the PnP apparatus 110 includes a number of operational components, including one or more of at least one robot 120, at least one end effector 130, a plurality of grippers 140, at least one grip sensor 142, at least one ply sensor 144, at least one compaction roller 150. In various examples, the inspecting apparatus 170 includes a number of operational components, including at least one vision sensor 172.

Referring particularly to FIG. 1 and generally to FIG. 8, in one or more examples, one or more steps of the method 1000 is electronically controlled or computer controlled (e.g., under the direction of or by instructions from a computer 500). In these examples, the system 100 also includes a computer 500 that is adapted (e.g., configured or programmed) to instruct or direct one or more of the operational components of the system 100 to perform one or more of the operational steps implemented by the method 1000. As such, in one or more examples, the method 1000 is an electronically-controller method or a computer-implemented method.

Referring to FIGS. 1 and 8, in one or more examples, the method 1000 includes a step of (block 1010) picking up the ply 210 of the ceramic matrix composite material 250 at a staging location 310. In one or more examples, the step of (block 1010) picking up the ply 210 is performed using the PnP apparatus 110 of the system 100. In one or more examples, picking up the ply 210 is performed automatically, for example, under direction from the computer 500. For example, the PnP apparatus 110 is programmed to automatically pick up the ply 210 at the staging location 310.

Referring to FIG. 8, in one or more examples, the PnP apparatus 110 includes at least one of the robot 120 and the end effector 130. In one or more examples, the robot 120 is any suitable type of programmable and articulating platform that is configured to selectively or controllably move the end effector 130 in three-dimensional space, such as a robotic arm, an overhead gantry, and the like. The end effector 130 is coupled to a working end of the robot 120. The end effector 130 is configured or adapted to interact with the ply 210 during the PnP process. In one or more examples, the end effector 130 includes or takes the form of any suitable gripper end effector for picking and placing a sheet (e.g., the ply 210) of the ceramic matrix composite material 250 on the forming surface 160. In one or more examples, the end effector 130 includes one or more tools, sensors, mechanisms, or devices to perform one or more operations on the ply 210.

Referring to FIG. 8, in one or more examples, the PnP apparatus 110 also includes the plurality of grippers 140. In one or more examples, the grippers 140 are coupled to or are otherwise integrated with the end effector 130. In one or more examples, the grippers 140 are configured to be removably or releasably coupled to a surface of the ply 210 during the PnP process. In one or more examples, one or more of the grippers 140 are vacuum grippers. In these examples, the grippers 140 utilize suction generated by a vacuum source to grip the surface of the ply 210. In one or more examples, one or more of the grippers 140 are electrostatic grippers. In these examples, the grippers 140 utilize electrostatic adhesion to grip the surface of the ply 210.

In one or more examples, each one of the plies 200 (e.g., ply 210) that is processed to provide the ceramic matrix composite structure 260 is sandwiched between a bottom backing layer 230 (e.g., a bottom backing film) and a top backing layer 232 (e.g., top backing film). Each one of the plies 200 (e.g., ply 210) has a geometry 240, a ply sequence number 242, and a fiber orientation 244. In one or more examples, the method 1000 includes a process for automated removal of the bottom backing layer 230 and the top backing layer 232.

Referring again to FIGS. 1 and 8, in one or more examples, the method 1000 includes a step of (block 1020) removing the bottom backing layer 230 from the ply 210 at a backing-removal location 312. In one or more examples, the step of (block 1020) removing the bottom backing layer 230 from the ply 210 is performed using the peeling apparatus 180 of the system 100. In one or more examples, removing the bottom backing layer 230 from the ply 210 is preformed automatically, for example, under direction from the computer 500. For example, the peeling apparatus 180 is programed to automatically remove the bottom backing layer 230 from the ply 210 at the backing-removal location 312.

In one or more examples, the ply 210 is moved from the staging location 310 to the backing-removal location 312 using the PnP apparatus 110. For example, with the ply 210 coupled to the grippers 140 of the end effector 130, the robot 120 moves the end effector 130 and the ply 210 from the staging location 310 to the backing-removal location 312, for example, under direction from the computer 500.

Referring to FIGS. 1 and 8, in one or more examples, the method 1000 includes a step of (block 1030) placing the ply 210 on the forming surface 160 at a forming location 314 after removing the bottom backing layer 230. In one or more examples, the step of (block 1030) placing the ply 210 on the forming surface 160 is performed using the PnP apparatus 110. In one or more examples, placing the ply 210 is performed automatically, for example, under direction from the computer 500. For example, the PnP apparatus 110 is programmed to automatically place the ply 210 at a desired or appropriate position on the forming surface 160. In one or more examples, the ply 210 is moved from the staging location 310, or the backing-removal location 312 in examples where the bottom backing layer 230 is removed, to the forming location 314 using the PnP apparatus 110. For example, with the ply 210 coupled to the grippers 140 of the end effector 130, the robot 120 moves the end effector 130 and the ply 210 from the staging location 310, or the backing-removal location 312, to the forming location 314, for example, under direction from the computer 500.

Referring still to FIGS. 1 and 8, in one or more examples, the method 1000 includes a step of (block 1040) compacting the ply 210 on the forming surface 160 after placing the ply 210 on the end effector 130. In one or more examples, the step of (block 1040) compacting the ply 210 on the forming surface 160 is performed using the PnP apparatus 110. In one or more examples, compacting the ply 210 is performed automatically, for example, under direction from the computer 500. For example, the PnP apparatus 110 is programmed to automatically compact the ply 210 according to a compaction path plan 430.

Referring to FIG. 8, in one or more examples, the PnP apparatus 110 includes the compaction roller 150. In one or more examples, the compaction roller 150 is coupled to or is otherwise integrated with the end effector 130. In one or more examples, the compaction roller 150 is configured to apply a compaction force to the ply 210, thereby compressing and compacting the ply 210 against the forming surface 160 and conforming the ply 210 to a shape 162 of the forming surface 160.

In one or more examples, the PnP apparatus 110 includes more than one instance of the robot 120 and/or more than one instance of the end effector 130. In one or more examples, the grippers 140 and the compaction roller 150 share a single instance of the end effector 130 (e.g., the same end effector). In one or more examples, the grippers 140 and the compaction roller 150 each have a dedicated instance of the end effector 130 (e.g., different end effectors).

Referring again to FIGS. 1 and 8, in one or more examples, the method 1000 includes a step of (block 1050) removing a top backing layer 232 from the ply 210 after compacting the ply 210 on the forming surface 160. In one or more examples, the step of (block 1050) removing the top backing layer 232 from the ply 210 is performed using the peeling apparatus 180. In one or more examples, removing the top backing layer 232 from the ply 210 is performed automatically, for example, under direction from the computer 500. For example, the peeling apparatus 180 is programmed to automatically remove the top backing layer 232 from the ply 210 at the forming location 314 after the ply 210 is compacted.

Referring to FIGS. 1 and 8, in one or more examples, the method 1000 includes a step of (block 1060) inspecting the ply 210 after compacting the ply 210 on the forming surface 160. In one or more examples, the step of (block 1060) is performed using an inspecting apparatus 170. In one or more examples, inspecting the ply 210 is performed automatically, for example, under direction from the computer 500. For example, the inspecting apparatus 170 is programmed to automatically inspect the ply 210 at the forming location 314 after the ply 210 is compacted.

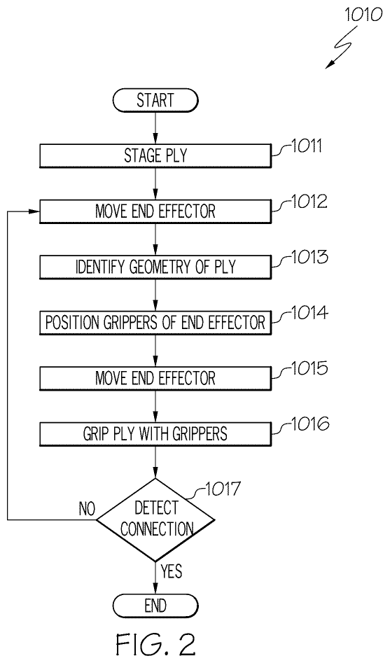

Referring generally to FIGS. 1 and 8 and particularly to FIG. 2, which illustrates an example of the step of (block 1010) picking up the ply 210 of the ceramic matrix composite material 250 at the staging location 310, according to one or more examples of the method 1000 (FIG. 1).

In one or more examples, the step of (block 1010) picking up the ply 210 includes a step of moving the robot 120 to a home position, thereby starting the pick-up operation.

Referring to FIGS. 2 and 8, in one or more examples, the step of (block 1010) picking up the ply 210 includes a step of (block 1011) staging the ply 210 at the staging location 310. In these examples, the ply 210 is physically staged (e.g., placed in a generally flat configuration) in the staging area for pick up by the end effector 130 of the PnP apparatus 110.

Referring to FIGS. 2 and 8, in one or more examples, the step of (block 1010) picking up the ply 210 includes a step of (block 1012) moving the end effector 130 to the staging location 310. In one or more examples, the end effector 130 is moved, for example, using the robot 120, from the home position to a pick-up position relative to a staging area at the staging location 310.

Referring to FIGS. 2 and 8, in one or more examples, the step of (block 1010) picking up the ply 210 includes a step of (block 1013) identifying a geometry 240 of the ply 210. In one or more examples, the geometry 240 of the ply 210 is detected and/or identified using the at least one ply sensor 144. In one or more examples, the ply sensor 144 is coupled to or is otherwise integrated with the end effector 130. In one or more examples, the ply sensor 144 includes or takes the form of an imaging device or other suitable vision sensor that is configured or operates to scan the staging area and identify the geometry 240 of the ply 210 based on the scan. As examples, the ply sensor 144 can include or take the form of a camera, a charge coupled device (CCD), a complementary metal oxide semiconductor (CMOS), a laser scanner, and the like.

Referring to FIGS. 2 and 8, in one or more examples, the step of (block 1010) picking up the ply 210 includes a step of (block 1014) positioning the grippers 140 of the end effector 130 based on the geometry 240 of the ply 210. In these examples, the grippers 140 are movable relative to the end effector 130 such that the grippers 140 can be selectively and appropriately positioned for gripping the ply 210. In one or more examples, the geometry 240 of each one of the plies 200 being placed to form the ceramic matrix composite structure 260 and the associated positions of the grippers 140 corresponding to the plies 200 are stored in a database 510 and are retrieved from the database 510 by the computer 500. The computer 500 then instructs the grippers 140 to move to the appropriate position for picking up the ply 210.

Referring to FIGS. 2 and 8, in one or more examples, the step of (block 1010) picking up the ply 210 includes a step of (block 1015) moving the end effector 130 to place the grippers 140 in contact with the ply 210. In these examples, the end effector 130 is moved, for example, by the robot 120, to a vision corrected position for placing the grippers 140 in contact with the ply 210 for gripping.

Referring to FIGS. 2 and 8, in one or more examples, with the grippers 140 in contact with the ply 210, the step of (block 1010) picking up the ply 210 includes a step of (block 1016) gripping the ply 210 with the grippers 140. In one or more examples, the grippers 140 grip the ply 210 using suction or vacuum. In one or more examples, the grippers 140 grip the ply 210 using electrostatic adhesion.

Referring to FIGS. 2 and 8, in one or more examples, the step of (block 1010) picking up the ply 210 includes a step of (block 1017) detecting whether the ply 210 is coupled to the grippers 140. In one or more examples, contact and/or proper grip between the grippers 140 and the ply 210 is detected using the at least one grip sensor 142. In one or more examples, the grip sensor 142 is coupled to or is otherwise integrated with the end effector 130. In one or more examples, the grip sensor 142 includes any suitable type of sensor or device that is configured or operates to detect contact and/or proper grip between the grippers 140 and the ply 210, depending, for example, of the type of grippers used and the grip technique. As examples, the grip sensor 142 can include or take the form of a vacuum sensor, a pressure sensor, contact sensor, a proximity sensor, and the like.

As illustrated in FIG. 2, when a determination of proper contact and/or grip, based on detecting (e.g., block 1017), is affirmative (i.e., contact and/or grip is sufficient), the robot 120 moves the end effector 130 and, thus, the ply 210 held by the end effector 130 to a safe exit position, thereby ending the pick-up operation. However, when the determination of proper contact and/or grip, based on detecting (e.g., block 1017), is negative (i.e., contact and/or grip is insufficient), the process returns to the step of (block 1012) moving the end effector 130 and the subsequent operational steps are repeated until contact and/or grip is determined to be sufficient.

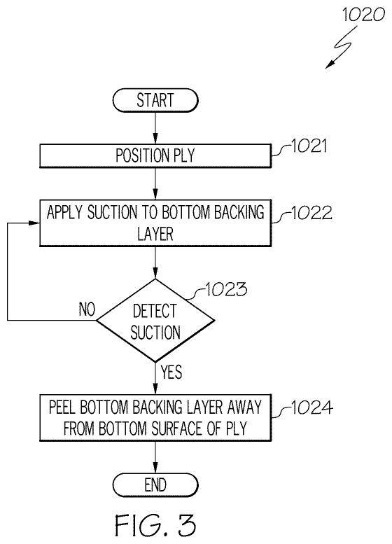

Referring generally to FIGS. 1 and 8 and particularly to FIG. 3, which illustrates an example of the step of (block 1020) removing the bottom backing layer 230 from the ply 210 at the backing-removal location 312, according to one or more examples of the method 1000 (FIG. 1).

Referring to FIGS. 3 and 8, in one or more examples, the step of (block 1020) removing the bottom backing layer 230 from the ply 210 includes a step of (block 1021) positioning the ply 210 at the backing-removal location 312 for removal of the bottom backing layer 230.

Referring to FIGS. 3 and 8, in one or more examples, the step of (block 1020) removing the bottom backing layer 230 from the ply 210 includes a step of (block 1022) applying suction to the bottom backing layer 230.

Referring to FIGS. 3 and 8, in one or more examples, the step of (block 1020) removing the bottom backing layer 230 from the ply 210 includes a step of (block 1023) detecting the suction.

Referring to FIGS. 3 and 8, in one or more examples, the step of (block 1020) removing the bottom backing layer 230 from the ply 210 includes a step of (block 1024) peeling the bottom backing layer 230 away from a bottom surface 214 of the ply 210.

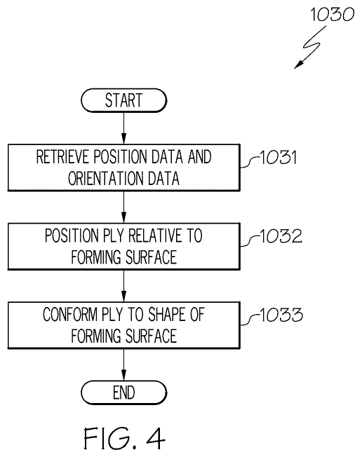

Referring generally to FIGS. 1 and 8 and particularly to FIG. 4, which illustrates an example of the step of (block 1030) placing the ply 210 on the forming surface 160, according to one or more examples of the method 1000.

Referring to FIGS. 4 and 8, in one or more examples, the step of (block 1030) placing the ply 210 on the forming surface 160 includes a step of (block 1031) retrieving position data 410 and orientation data 420 based on the geometry 240 of the ply 210 and a ply sequence number 242 of the ply 210.

Referring to FIGS. 4 and 8, in one or more examples, the step of (block 1030) placing the ply 210 on the forming surface 160 includes a step of (block 1032) positioning the ply 210 at the forming location 314 relative to the forming surface 160 based on the position data 410 and the orientation data 420.

Referring to FIGS. 4 and 8, in one or more examples, the step of (block 1030) placing the ply 210 on the forming surface 160 includes a step of (block 1033) conforming the ply 210 to the shape 162 of the forming surface 160.

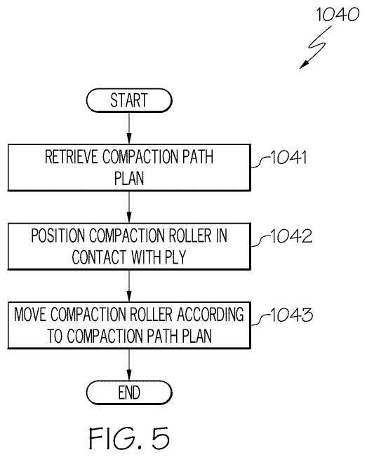

Referring generally to FIGS. 1 and 8 and particularly to FIG. 5, which illustrates an example of the step of (block 1040) compacting the ply 210 on the forming surface 160, according to one or more examples of the method 1000.

Referring to FIGS. 5 and 8, in one or more examples, the step of (block 1040)

compacting the ply 210 on the forming surface 160 includes a step of (block 1041) retrieving a compaction path plan 430 based on the geometry 240 of the ply 210 and the ply sequence number 242 of the ply 210.

Referring to FIGS. 5 and 8, in one or more examples, the step of (block 1040) compacting the ply 210 on the forming surface 160 includes a step of (block 1042) positioning the compaction roller 150 in contact with the ply 210.

Referring to FIGS. 5 and 8, in one or more examples, the step of (block 1040) compacting the ply 210 on the forming surface 160 includes a step of (block 1043) moving the compaction roller 150 across the ply 210 along a compaction path 432 according to the compaction path plan 430.

In one or more examples, compacting the ply 210 includes a step of positioning the compaction roller 150 in contact with a ply-surface (e.g., the top backing layer 232 before being removed) of the ply 210 of the ceramic matrix composite material 250. Compacting the ply 210 also includes a step of applying a compaction pressure to the ply 210 using the compaction roller 150 such that the compaction pressure is substantially uniformly distributed on the ply 210. With the compaction roller 150 in contact with the ply 210 and applying the compaction pressure, compacting the ply 210 further includes a step of moving the compaction roller 150 across the ply 210, for example, along the compaction path 432, to conform the ply 210 to the forming surface 160.

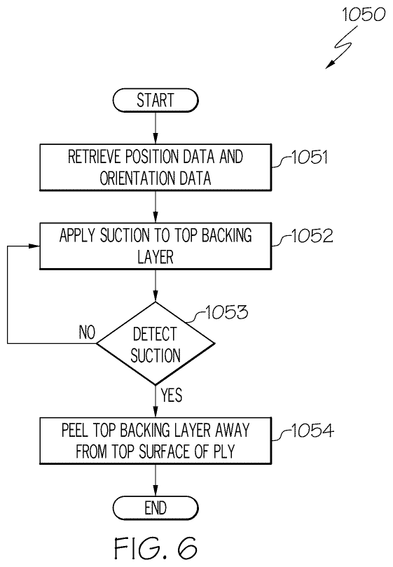

Referring generally to FIGS. 1 and 8 and particularly to FIG. 6, which illustrates an example of the step of (block 1050) removing the top backing layer 232 from the ply 210, according to one or more examples of the method 1000.

Referring to FIGS. 6 and 8, in one or more examples, the step of (block 1050) removing the top backing layer 232 from the ply 210 includes a step of (block 1051) retrieving the position data 410 and the orientation data 420 based on the geometry 240 of the ply 210 and the ply sequence number 242 of the ply 210.

Referring to FIGS. 6 and 8, in one or more examples, the step of (block 1050) removing the top backing layer 232 from the ply 210 includes a step of (block 1052) applying suction to a corner of the top backing layer 232.

Referring to FIGS. 6 and 8, in one or more examples, the step of (block 1050) removing the top backing layer 232 from the ply 210 includes a step of (block 1053) detecting the suction.

Referring to FIGS. 6 and 8, in one or more examples, the step of (block 1050) removing the top backing layer 232 from the ply 210 includes a step of (block 1054) peeling the top backing layer 232 away from the top surface 212 of the ply 210.

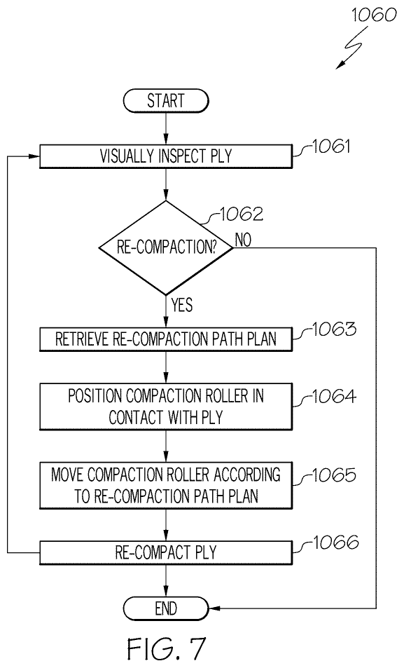

Referring generally to FIGS. 1 and 8 and particularly to FIG. 7, which illustrates an example of the step of (block 1060) inspecting the ply 210 after compacting the ply 210 on the forming surface 160, according to one or more examples of the method 1000.

Referring to FIGS. 7 and 8, in one or more examples, the step of (block 1060) inspecting the ply 210 after compacting the ply 210 on the forming surface 160 includes a step of (block 1061) visually inspecting the ply 210.

In one or more examples, the ply 210 is inspected using the inspecting apparatus 170, such as the at least one vision sensor 172. In these examples, results 440, such as measurement data, image data, images, etc.) from the vision sensor 172 are used to detect nonconformities in the ply 210 after compaction. In one or more examples, the results 440 are transmitted to and processed and/or analyzed by the computer 500 to determine the type and/or characteristic of any nonconformities. Depending on the type and/or characteristic of a detected nonconformity, re-COMPACTION may be necessary. In one or more examples, the vision sensor 172 includes or takes the form of an imaging device or other suitable vision sensor that is configured or operates to scan the ply 210 on the forming surface 160 after compaction and generate data (e.g., results 440) that can be processed to detect nonconformities. As examples, the ply sensor 144 can include or take the form of a camera, a charge coupled device (CCD), a complementary metal oxide semiconductor (CMOS), a laser scanner, a line scanner, a 2D scanner, a 3D scanner, and the like.

Referring to FIGS. 7 and 8, in one or more examples, the step of (block 1060) inspecting the ply 210 after compacting the ply 210 on the forming surface 160 includes a step of (block 1062) determining whether re-compaction is necessary based on the results 440 of visual inspection.

As illustrated in FIG. 7, when the determination is negative (i.e., re-compaction is not needed), the process ends. However, when the determination is affirmative (i.e., re-compaction is needed), the process proceeds to operational steps directed to re-work, including re-compaction and subsequent inspection.

Referring to FIGS. 7 and 8, in one or more examples, the step of (block 1060) inspecting the ply 210 after compacting the ply 210 on the forming surface 160 includes a step of (block 1063) retrieving a re-compaction path plan 450. As an example, the re-compaction path plan 450 is retrieved from the database 510 by the computer 500.

Referring to FIGS. 7 and 8, in one or more examples, the step of (block 1060) inspecting the ply 210 after compacting the ply 210 on the forming surface 160 includes a step of (block 1064) positioning the compaction roller 150 in contact with the ply 210.

Referring to FIGS. 7 and 8, in one or more examples, the step of (block 1060) inspecting the ply 210 after compacting the ply 210 on the forming surface 160 includes a step of (block 1065) moving the compaction roller 150 across the ply 210 along a re-compaction path 452 according to the re-compaction path plan 450.

Referring to FIGS. 7 and 8, in one or more examples, the step of (block 1060) inspecting the ply 210 after compacting the ply 210 on the forming surface 160 includes a step of (block 1066) re-compacting the ply 210 on the forming surface 160 when re-compaction is necessary.

Referring again to FIGS. 1 and 8, in one or more examples, the method 1000 includes a step of (block 1070) cleaning the compaction roller 150 used for compacting the ply 210 on the forming surface 160.

The present disclosure recognizes that during compaction of the ply 210 of the ceramic matrix composite material 250, some amount of debris, such as from the ply 210 or other foreign objects, may remain on a compaction-roller surface of the compaction roller 150. The debris can include amounts of the ceramic matrix 254, such as amounts of the ceramic particles 256 and/or the suspension media 258. The debris can also include fragments of the ceramic reinforcement 252. As such, examples of the method 1000 and the system 100 disclosed herein provide techniques and mechanisms for easily and efficiently cleaning the compaction-roller surface of the compaction roller 150 after ply compaction and/or re-compaction.

Referring to FIG. 1, in one or more examples, the method 1000 includes a step of (block 1080) determining whether another one of the plies 200 of the ceramic matrix composite material 250 is to the added for the manufacturing of the ceramic matrix composite structure 260. If the determination is affirmative (i.e., another ceramic matrix composite ply is to be added), the process returns to the step of (block 1010) picking up the ply 210 to process the next one of the plies 200 of the ceramic matrix composite material 250. However, if the determination is negative (i.e., there is no additional ceramic matrix composite ply), the process ends with a step of (block 1090) completing the ceramic matrix composite structure 260 and the process ends.

Referring now to FIG. 8, the following are examples of the system 100 for manufacturing the ceramic matrix composite structure 260, according to the present disclosure. The system 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

In one or more examples, the PnP apparatus 110 is configured or operates to pick up the ply 210 of the ceramic matrix composite material 250 at the staging location 310. The PnP apparatus 110 is also configured or operates to place the ply 210 on the forming surface 160 at the forming location 314. The PnP apparatus 110 is further configured or operates to compact the ply 210 on the forming surface 160.

In one or more examples, the peeling apparatus 180 is configured or operates to remove the bottom backing layer 230 from the ply 210 at the backing-removal location 312 before the ply 210 is placed on the forming surface 160. The peeling apparatus 180 is also configured or operates to remove the top backing layer 232 from the ply 210 after the ply 210 is compacted on the forming surface 160.

In one or more examples, the inspecting apparatus 170 is configured or operates to inspect the ply 210 after the ply 210 is compacted on the forming surface 160.

In one or more examples, the system 100 includes the tool 164. The tool 164 includes a tool surface 166. In one or more examples, during the layup process described above by the method 1000, an initial one of the plies 200 of the ceramic matrix composite material 250 is placed and compacted on the tool surface 166. In these examples, the tool surface 166 forms or defines the forming surface 160, at least for the initial one of the plies 200 formed on the tool 164. In one or more examples, during the layup process described above by the method 1000, subsequent or additional ones of the plies 200 of the ceramic matrix composite material 250 are placed and compacted on a prior-ply surface 222 of a prior-ply 220. In these examples, the prior-ply surface 222 forms or defines the forming surface 160, at least for subsequent or additional ones of the plies 200. As such, a shape of the tool 164 or a contour of the tool surface 166 generally defines the shape 162 or the contour 168 of the forming surface 160 upon which the plies 200 are formed (e.g., placed and compacted). The tool 164 can have any suitable geometry or shape. Similarly, the tool surface 166 can have any suitable geometry or profile shape. As examples, the tool surface 166 can have any suitable contour, such as flat (e.g., planar), curved, or a combination of flat portions and curved portions (e.g., simple or complex contours). The method 1000 and the system 100 enable forming (e.g., placing and compacting) of individual ones of the plies 200 of the ceramic matrix composite material 250 (e.g., ply-by-ply) to conform to the shape 162 and/or the contour 168 of the forming surface 160 and, thus, the manufacture of the ceramic matrix composite structure 260.

In one or more examples, the PnP apparatus 110 includes the robot 120 and the end effector 130. The end effector 130 is coupled to the robot 120 and is configured to interact with the ply 210 during one or more of the picking, peeling, placing, compacting, and inspecting operations.

In one or more examples, the PnP apparatus 110 includes a plurality of the grippers 140, at least one ply sensor 144, and at least one grip sensor 142. The grippers 140 are coupled to the end effector 130. Each one of the grippers 140 is configured or operates to grip or otherwise secure and hold the ply 210 during the picking, peeling, and placing operations. The at least one ply sensor 144 is configured or operates to identify the geometry 240 of the ply 210. The at least one grip sensor 142 is configured or operates to detect whether the grippers 140 are coupled to the ply 210.

In one or more examples, the end effector 130 includes a base and at least one arm, such as a plurality of arms. In one or more examples, the grippers 140 are coupled to the base and to each one of the arms. In one or more examples, the arms are coupled to the base and extend outward from the base. As such, the base and the arms generally position the grippers 140 for contact with and gripping of the ply 210. In one or more examples, the arms are movable, for example, linearly movable and/or rotationally movable, relative to the base. As such, movement of the arms relative to the base enables the end effector 130 to selectively or sequentially place different portions of the ply 210 on the forming surface 160 and controllably drape portions of the ply 210 over curved portions of the forming surface 160 and/or radiused edges of the forming surface 160. Additionally, movement of the arms relative to the base enables the end effector 130 to apply tension to the ply 210 during placement and formation on the forming surface 160, thereby preventing the ply 210 from sagging during placement. In one or more examples, the grippers 140 are movable, for example, linearly moveable or rotationally movable, relative to the arms and/or the base. As such, movement of the grippers 140 relative to the base and/or the arms enables the end effector 130 to selectively position the grippers 140 for picking up and placing the ply 210, for example, based on the //240 of the ply 210. In one or more examples, with the ply 210 held by the grippers 140, the robotic 120 moves the ply 210 relative to the forming surface 160 such that a first ply-portion is placed on a first surface-portion of the forming-surface. Further, with the ply 210 held by the grippers 140, an arm can move relative to the base and the forming surface 160 such that a second ply-portion of the ply 210 is draped over a radiused corner of the forming surface 160 between the first surface-portion and the second surface-portion of the forming surface 160 and the second ply-portion of the ply 210 is placed on the second surface-portion of the forming surface 160.

In one or more examples, the PnP apparatus 110 includes the compaction roller 150. The compaction roller 150 is coupled to the end effector 130. The compaction roller 150 is configured or operates to apply a compaction force or compaction pressure to the ply 210 when placed in contact with the ply 210 and moved along the ply 210, for example, by the robot 120.

The present disclosure recognizes the advantages of using a compaction roller having specialized material characteristics to compact the plies 200 of the ceramic matrix composite material 250 in a similar manner to a smoothing process used during manual layup and that addresses the compaction needs for ceramic matrix composite manufacturing. In one or more examples, a material for the compaction roller 150 is selected such that the plies 200 of the ceramic matrix composite material 250 can be compacted using the compaction roller 150 to conform the ply 210 to the shape 162 and/or contour 168 of the forming surface 160 and maintain a desired thickness of the ply 210 while moving the compaction roller 150 across the ply 210 without migration of the ceramic matrix 254 and without undesired deformation (e.g., wrinkling, bubbling, pleating, puckering, bridging, or other deformities) of the fabric weave of the ceramic reinforcement 252 of the ply 210. In one or more examples, the compaction roller 150 includes a compaction-roller axis and a compaction-roller surface that circumscribes the compaction-roller axis. In one or more examples, the compaction roller includes a core and a covering that surrounds the core. In one or more examples, a covering material of the covering includes one of a foam material, a closed-cell foam material, or an inflatable bladder. In one or more examples, the covering material of the covering is impermeable. In one or more examples, the covering material includes at least one of silicone, urethane, polyurethane, and latex. In one or more examples, the covering material of the compaction roller 150 includes a Shore A hardness of between approximately 1 and 10, such as between approximately 3 and 7, such as approximately 5. Advantageously, the compliance of the roller material of the compaction roller 150 provides pressure uniformity without localized high pressure peaks, such that a variation in the compaction pressure along a contact interface between the compaction roller 150 and the ply 210 is less than approximately 5 PSI, such as less than approximately 3 PSI. such as less than approximately 1 PSI. The softness of the roller material allows for smoothing of the ply 210 during rollout compaction without reinforcement distortion or matrix migration, while effectively eliminating large, trapped air bubbles.

In one or more examples, the system 100 includes the computer 500. The computer 500 is adapted to retrieve the position data 410 and the orientation data 420, for example, from the database 510, based on the geometry 240 of the ply 210 and the ply sequence number 242 of the ply 210. The ply 210 is placed (e.g., positioned and oriented) at the forming location 314 relative to the forming surface 160 by the pick and place apparatus 110 based on the position data 410 and orientation data 420, for example, as directed by the computer 500.

In one or more examples, the computer 500 is adapted to retrieve the compaction path plan 430, for example, from the database 510, based on the geometry 240 of the ply 210 and the ply sequence number 242 of the ply 210. The robot 120 is configured or operates to move the compaction roller 150 across the ply 210 along the compaction path 432 according to the compaction path plan 430, for example, as directed by the computer 500.

In one or more examples, the system 100 includes the cleaning apparatus 190. The cleaning apparatus 190 is configured or operates to clean the ceramic matrix 254 (e.g., remnants of the ceramic particles 256 and/or the suspension media 258) from the compaction roller 150. In some cases, the cleaning apparatus 190 is configured or operates to also clean remnants of the ceramic reinforcement 252 and/or other foreign debris from the compaction roller 150.

In one or more examples, the inspecting apparatus 170 includes at least one vision sensor 172. The at least one vision sensor 172 is configured or operates to detect deformations in the ply 210 after the ply 210 is compacted on the forming surface 160.

In one or more examples, the computer 500 is adapted to determine whether re-compaction is necessary based on the results 440 generated by the vision sensor 172. The computer 500 is also adapted to retrieve the re-compaction path plan 450, for example, from the database 510. The robot 120 is configured or operates to move the compaction roller 150 across the ply 210 along the re-compaction path 452 according to the re-compaction path plan 450, for example, as directed by the computer 500.

Referring to FIG. 8, in one or more examples, the computer 500 includes a data-processing system 502 configured to received, analyze, generate, and/or transmit various types of data, information, and/or signals, for example, to control or otherwise provide instructions operational components of the system 100 and/or perform the steps of the method 1000. In one or more examples, the data-processing system 502 includes a processor 504 and memory 506 storing instructions (e.g., program code 508) that, when executed, cause the processor 504 to initiate performance of one or more operational steps of the method 1000 or instructs the system 100 to perform one or more operational steps of the method 1000. In one or more examples, the processor 504 is configured to read from and write to the memory 506. In one or more examples, the processor 504 is configured to receive input commands and provide output commands. In one or more examples, the processor 504 is a multi-functional processor such as, for example, a central processing unit. In one or more examples, the functions of the processor 504 are performed by a local processor, a remote processor, or a combination thereof. In one or more examples, the processor 504 is implemented in hardware alone (e.g., a circuit, a microprocessor etc.) have certain aspects in software including firmware alone or can be a combination of hardware and software (including firmware). In one or more examples, the processor 504 can be implemented using instructions that enable hardware functionality, for example, by using executable computer program instructions (e.g., program code 508) in a general-purpose or special-purpose processing unit that is stored on the memory 506 or other computer readable storage medium (e.g., disk, memory, etc.) to be executed by the processor 504. The memory 506 stores a computer program (e.g., program code 508) that includes computer program instructions that control the operation of the processor 504 when loaded into processing circuitry. The computer program instructions provide the logic and routines that enable the processor 504 to perform one or more operations according to the method 1000. The processing circuitry, by reading the memory 506, is able to load and execute the program code 508. The program code 508 may arrive at the processor 504 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program. The delivery mechanism may be a signal configured to reliably transfer the computer program. The apparatus may propagate or transmit the computer program as a computer data signal. Although the memory 506 is illustrated as a single component it may be implemented as one or more separate components some or all of which may be integrated/removable and/or may provide permanent/semi-permanent/dynamic/cached storage. References to “computer-readable storage medium,” “computer program product,” “tangibly embodied computer program,” etc. or a “controller,” “computer,” “processor,” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

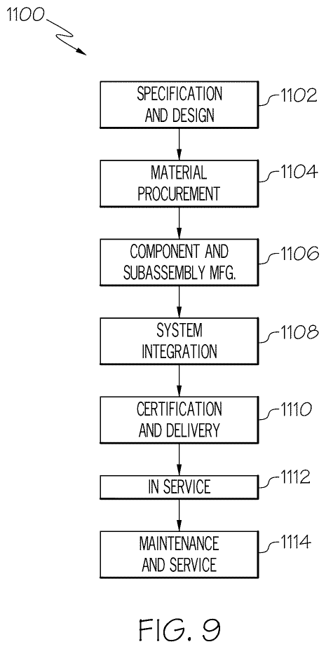

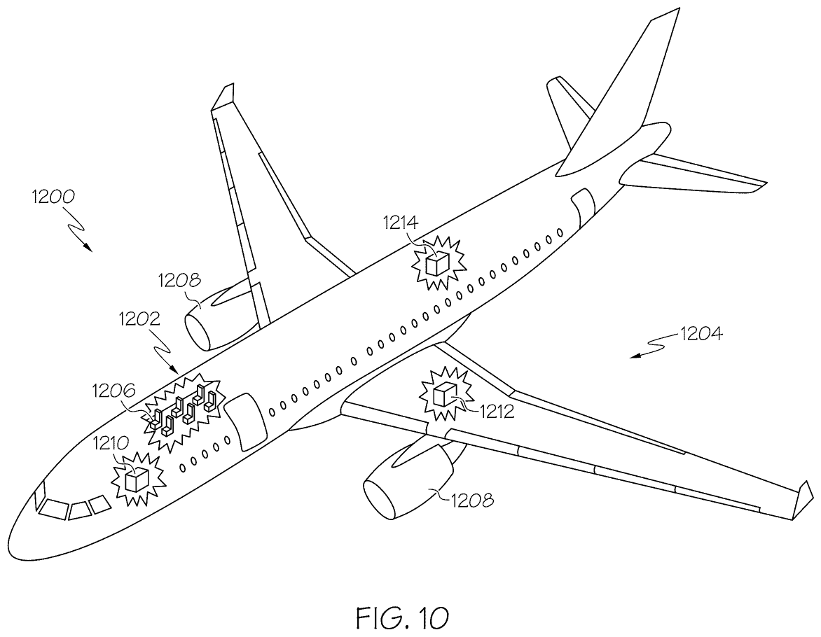

Referring now to FIGS. 9 and 10, examples of the method 1000 and the system 100 described herein, may be related to, or used in the context of, the aerospace manufacturing and service method 1100, as shown in the flow diagram of FIG. 9 and an aircraft 1200, as schematically illustrated in FIG. 10. As an example, the aircraft 1200 and/or the manufacturing and service method 1100 may include or utilize components that are manufactured of ceramic matrix composite structures, which are manufacturing using the system 100 and/or according to the method 1000.

Referring to FIG. 10, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of components made of ceramic matrix composite materials, such as ceramic matrix composite structures that are manufactured using system 100 and/or according to the method 1000.

Referring to FIG. 9, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 9 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the method 1000 and the system 100, shown and described herein, may be employed during any one or more of the stages of the manufacturing and service method 1100 shown in the flow diagram illustrated by FIG. 9. In an example, components of the aircraft 1200 can be manufactured of ceramic matrix composite materials, which are manufactured using the system 100 and/or according to the method 1000 during a portion of component and subassembly manufacturing (block 1106) and/or system integration (block 1108). Further, components of the aircraft 1200 can be manufactured of ceramic matrix composite materials, which are manufactured using the system 100 and/or according to the method 1000 while the aircraft 1200 is in service (block 1112). Also, components of the aircraft 1200 can be manufactured of ceramic matrix composite materials, which are manufactured using the system 100 and/or according to the method 1000 during system integration (block 1108) and certification and delivery (block 1110). Similarly, components of the aircraft 1200 can be manufactured of ceramic matrix composite materials, which are manufactured using the system 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 8 and 10, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 8 and 10, referred to above, need be included in every example and not all elements, features, and/or components described herein are necessarily depicted in each illustrative example. Accordingly, some of the elements, features, and/or components described and illustrated in FIGS. 8 and 10 may be combined in various ways without the need to include other features described and illustrated in FIGS. 8 and 10, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 8 and 10, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 8 and 10, and such elements, features, and/or components may not be discussed in detail herein with reference to each of FIGS. 8 and 10. Similarly, all elements, features, and/or components may not be labeled in each of FIGS. 8 and 10, but reference numerals associated therewith may be utilized herein for consistency.

In FIGS. 1-7 and 9, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 1-7 and 9 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100 and the method 1000 have been shown and described, modifications may occur to those skilled in the art upon reading the specification. The present application includes such modifications and is limited only by the scope of the claims.

What is claimed is:

1. A method for manufacturing a ceramic matrix composite structure, the method comprising:
picking up a ply of a ceramic matrix composite material at a staging location;
removing a bottom backing layer from the ply at a backing-removal location;
placing the ply on a forming surface at a forming location after removing the bottom backing layer;
compacting the ply on the forming surface;
removing a top backing layer from the ply after compacting the ply on the forming surface; and
inspecting the ply after compacting the ply on the forming surface.

2. The method of claim 1, wherein picking up the ply comprises:
staging the ply at the staging location;
moving an end effector to the staging location;
identifying a geometry of the ply;
positioning grippers of the end effector based on the geometry of the ply;
moving the end effector to place the grippers in contact with the ply;
with the grippers in contact with the ply, gripping the ply with the grippers; and
detecting whether the ply is coupled to the grippers.

3. The method of claim 1, wherein removing the bottom backing layer from the ply comprises:
positioning the ply at the backing-removal location for removal of the bottom backing layer;
applying suction to the bottom backing layer;
detecting the suction; and
peeling the bottom backing layer away from a bottom surface of the ply.

4. The method of claim 1, wherein placing the ply on the forming surface comprises:
retrieving position data and orientation data based on a geometry of the ply and a ply sequence number of the ply;
positioning the ply at the forming location relative to the forming surface based on the position data and the orientation data; and
conforming the ply to a shape of the forming surface.

5. The method of claim 1, wherein compacting the ply on the forming surface comprises:
retrieving a compaction path plan based on a geometry of the ply and a ply sequence number of the ply;
positioning a compaction roller in contact with the ply; and
moving the compaction roller across the ply along a compaction path according to the compaction path plan.

6. The method of claim 5, further comprising cleaning the compaction roller used for compacting the ply on the forming surface.

7. The method of claim 1, wherein removing the top backing layer from the ply comprises:
retrieving position data and orientation data based on a geometry of the ply and a ply sequence number of the ply;
applying suction to a corner of the top backing layer;
detecting the suction; and
peeling the top backing layer away from a top surface of the ply.

8. The method of claim 1, wherein inspecting the ply after compacting the ply on the forming surface comprises:
visually inspecting the ply;
determining whether re-compaction is necessary based on results of visual inspection; and
re-compacting the ply on the forming surface when re-compaction is necessary.

9. The method of claim 8, wherein inspecting the ply after compacting the ply on the forming surface further comprises:
retrieving a re-compaction path plan;
positioning a compaction roller in contact with the ply; and
moving the compaction roller across the ply along a re-compaction path according to the re-compaction path plan.

10. A method for manufacturing a portion of an aircraft comprising the method of claim 1.

11. A ceramic matrix composite structure manufactured according to the method of claim 1.

12. A system for manufacturing a ceramic matrix composite structure, the system comprising:
a pick and place apparatus configured to:
pick up a ply of a ceramic matrix composite material at a staging location;
place the ply on a forming surface at a forming location; and
compact the ply on the forming surface;
a peeling apparatus configured to:
remove a bottom backing layer from the ply at a backing-removal location before the ply is placed on the forming surface; and
remove a top backing layer from the ply after the ply is compacted on the forming surface; and
an inspecting apparatus configured to inspect the ply after the ply is compacted on the forming surface.

13. The system of claim 12, wherein the pick and place apparatus comprises:
a robot; and
an end effector coupled to the robot and configured to interact with the ply.

14. The system of claim 13, wherein the pick and place apparatus further comprises:
a plurality of grippers coupled to the end effector;
at least one ply sensor configured to identify a geometry of the ply; and
at least one grip sensor configured to detect whether the grippers are coupled to the ply.

15. The system of claim 13, wherein the pick and place apparatus further comprises a compaction roller coupled to the end effector.

16. The system of claim 15, further comprising a computer adapted to retrieve position data and orientation data based on a geometry of the ply and a ply sequence number of the ply, wherein the ply is placed at the forming location relative to the forming surface by the pick and place apparatus based on the position data and orientation data.

17. The system of claim 15, further comprising a computer adapted to retrieve a compaction path plan based on a geometry of the ply and a ply sequence number of the ply,
wherein the robot moves the compaction roller across the ply along a compaction path according to the compaction path plan.

18. The system of claim 15, further comprising a cleaning apparatus configured to clean a ceramic matrix from the compaction roller.

19. The system of claim 15, wherein the inspecting apparatus comprises at least one vision sensor configured to detect deformations in the ply after the ply is compacted on the forming surface.

20. The system of claim 19, further comprising a computer adapted to:
determine whether re-compaction is necessary based on results generated by the vision sensor; and
retrieve a re-compaction path plan,
wherein the robot moves the compaction roller across the ply along a re-compaction path according to the re-compaction path plan.
